(19) United States
(12) Patent Application Publication
(10) Pub. No.: US 2009/0183892 A1
(43) Pub. Date: Jul. 23, 2009

(54) Temperature-resistant electrical line

(75) Inventor: Gerhard Ziemek, Langenhagen (DE)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Ziemek Cable Technology GmbH

(21) Appl. No.: 12/319,909

(22) Filed: Jan. 12, 2009

(30) Foreign Application Priority Data
Jan. 17, 2008 (DE) 102008004781.3

(51) Int. Cl. H01B 9/02; B23P 19/00

(52) U.S. Cl. 174/108; 29/745

(57) ABSTRACT

A temperature-resistant electrical line comprises at least one central electrical conductor, an insulation, which is made from a mineral material and surrounds the electrical conductor completely, and a metallic outer tube, which bears against the insulation. The outer tube (3) has, over its entire length, a helical notch (4), which is open to the outside, and which is produced once the line is finished by means of a metal-removing tool and whose depth is at least 50% of the wall thickness of the outer tube (3), with a residual wall thickness (5) which ensures the stability thereof.

### CROSS REFERENCE TO RELATED APPLICATION

This application claims priority under 35 USC §119 to German Patent Application No. DE 102008004781.3 which was filed on Jan. 17, 2008.

### TECHNICAL FIELD

The invention relates to a temperature-resistant electrical line, comprising at least one central electrical conductor, insulation, which is made from a mineral material and surrounds the electrical conductor all the way around, and a metallic outer tube, which bears against the insulation.

### BACKGROUND OF THE INVENTION

Such lines are known and have been available on the market for years. They are used, for example, as heating lines when very high temperatures in the region of 500° C. and more are intended to be produced. Since these lines do not burn as a result of their mineral insulation, they are also used in sectors with increased risk of fire. In order to produce them, first at least one electrical conductor is arranged centrally in a metallic, primarily steel or copper outer tube with a relatively short length of 2 m, for example. The space between the conductor and the outer tube is then filled with a mineral material, such as magnesium oxide or aluminium oxide, for example, which is applied by means of a press or a die and in the process is compressed with considerable force to such an extent that the conductor is firmly enclosed. The outer tube needs to withstand the resultant loading without being damaged. It therefore has a relatively large wall thickness. After the compression of the insulation, the line is reduced in terms of its diameter by so-called drawing-down and in the process is overall extended to a length of up to 1000 m, that is even the conductor which has been fixedly enclosed by the insulation. The line is also flexurally rigid after the drawing-down as a result of the construction described because the outer tube is still relatively thick. It can therefore not be further-processed using conventional methods and machines in cable technology and cannot be transported using conventional transport means, in particular spools.

### SUMMARY OF THE INVENTION

The invention is based on the object of designing the line described at the outset in such a way that it can be further-processed using methods and machines which are conventional in cable technology and can be transported.

This object is achieved according to the invention by virtue of the fact that the outer tube has, over its entire length, a notch, which is open on the outside, runs in a helical fashion, is produced once the line is finished by means of a metal-removing tool and whose depth is at least 50% of the wall thickness of the outer tube, with a residual wall thickness which ensures the stability thereof.

The overall bending resistance of the line is determined in terms of dimensions by its outer tube, referred to below as “tube” for short, with its large wall thickness. The flexibility of the tube in the case of this line is substantially increased by the notch produced in it once it is finished, so that the entire line also becomes elastically so flexible that it can be stranded, for example, together with other stranding elements, using conventional stranding machines. The line can also be manufactured with a greater length and be wound onto a spool and be unwound from the spool again for laying purposes. The tube, despite the notch, maintains its high transverse stability, with the result that the line is not damaged by radial loads and in particular the mineral insulation is effectively protected. As a result of the notch, the outer surface of the tube is also enlarged, so that, as an additional advantage of this line during use thereof for heating purposes, the heat transfer to its surrounding environment is improved as a result of the enlarged transfer area for the heat produced by the conductor, which is then in the form of a heating conductor.

### BRIEF DESCRIPTION OF THE DRAWINGS

An exemplary embodiment of the subject of the invention is illustrated in the drawings, in which:

FIG. 1 shows a schematic illustration of a cross section through a mineral-insulated line.

FIG. 2 shows the line according to the invention.

### DETAILED DESCRIPTION

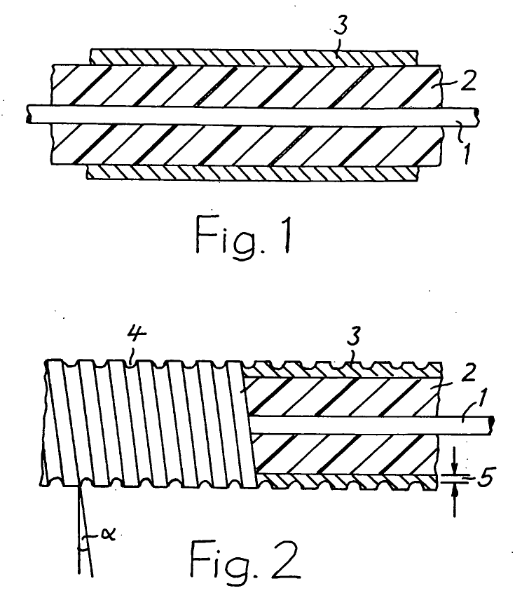

The line illustrated schematically in FIG. 1 as a section is known per se. It has a central electrical conductor 1, which is surrounded by insulation 2 made from a mineral material. In a preferred embodiment, the conductor 1 is a heating conductor. As a deviation from the illustration in the drawing, two or more conductors may also be provided. A metallic tube 3, which is preferably made from steel and bears against the insulation 2, is fitted over said insulation 2. The line has been produced corresponding to the method described at the outset. It therefore already has the reduced dimensions in comparison with the initial form. These dimensions are, for example, 17.5 mm for the outer diameter of the insulation 2 and 1.5 mm for the wall thickness of the tube 3. As a result of this thick tube 3, the line, which without the tube is flexible per se, is so rigid that, as has already been mentioned further above, it cannot be further-processed using methods and machines conventional in cable technology and also cannot be transported in the conventional way in which it is wound on spools.

In the case of the line according to the invention, a helically running notch 4 is fitted in the tube 3 as shown in FIG. 2, which notch 4 has been produced once the line is finished using a metal-cutting tool. This can be carried out in a continuous process with a tool rotating around the line, while the line is moved in its axial direction. The notch 4 is provided over the entire length of the line. Its depth is at least 50% of the wall thickness of the tube 3. In this case, in order to ensure sufficient stability of the tube 3, a residual wall thickness 5 needs to remain which is, for example, 30% of the wall thickness. This means that at least approximately a third of the wall thickness of the tube 3 needs to be maintained in the region of the notch 4 in order to ensure the protection of the insulation 2 even in the event of relatively great loads. The width of the notch 4 preferably corresponds to the wall thickness of the tube 3.

As a result of the notch 4, the tube 3 is so very flexible that the line overall can be handled as a conventional electrical line. It can be manufactured in a long length, stranded with other lines and wound onto a spool. The line can also be laid in a simple manner by being drawn from the spool, its good flexibility proving to be particularly advantageous when the line is intended to be introduced in bent channels.

In order to ensure the good flexibility of the tube 3 and therefore the line, the turns of the notch 4 in the preferred embodiment are relatively close next to one another. In this sense, the lead angle α (FIG. 2) of the notch 4 is intended to be a maximum of 15°. It is particularly advantageously 5°.

In order to rule out the possibility of the tube 3 in the notch 4 breaking when the line is bent, the base of the notch 4 is advantageously bent. The radius of the bend in this case preferably corresponds to half the width of the notch 4.

As can be seen in FIG. 2, the outer surface of the tube 3 does not run in a straight line, but is approximately meandering. As a result, it is enlarged in comparison with that of a smooth tube. For the case in which the line in the preferred embodiment is a heating line with a conductor 1, which is then in the form of a heating conductor, this results in an enlarged transfer area for the heat produced by the heating conductor 1. The heat transfer to the surrounding environment of the line is thereby improved.

What is claimed is:

1. A temperature-resistant electrical line, comprising at least one central electrical conductor, an insulation, which is made from a mineral material and surrounds said electrical conductor completely, and a metallic outer tube, which bears against the insulation, wherein the outer tube has, over its entire length, a notch, which is open to the outside, which runs in the form of a helix, and whose depth is at least 50 percent of the wall thickness of the outer tube, and has a residual wall thickness which ensures the stability thereof.

2. The line according to claim 1, wherein the width of the notch is equal to the wall thickness of the outer tube.

3. The line according to claim 2, wherein the pitch angle of the notch is 15 degrees at its maximum.

4. The line according to claim 3, wherein the pitch angle of the notch is 5 degrees.

5. The line according to claim 4, wherein the base of the notch is curved with a radius which is approximately equal to half the width of the notch.

6. The line according to claim 5, wherein the conductor is a heating conductor.

7. The line according to claim 1, wherein the pitch angle of the notch is 15 degrees at its maximum.

8. The line according to claim 7, wherein the pitch angle of the notch is 5 degrees.

9. The line according to claim 1, wherein the base of the notch is curved with a radius which is approximately equal to half the width of the notch.

10. The line according to claim 9, wherein the conductor is a heating conductor.

11. The line according to claim 1, wherein the conductor is a heating conductor.

12. A method of making a temperature-resistant electrical line, comprising:
completely surrounding an electrical conductor with an insulation formed from a mineral material;
fitting a metallic outer tube so as to bear against the insulation;
forming a helical notch which is open to the outside in the metallic outer tube, so that the notch has a depth of at least 50 percent of the wall thickness of the outer rube and so that the outer tube has a residual wall thickness that ensures stability thereof.

13. The method of claim 12, wherein the notch has a width which is equal to the wall thickness of the outer tube.

14. The method of claim 12, wherein the notch has a pitch angle that is 15 degrees at its maximum.

15. The method of claim 14, wherein the pitch angle of the notch is 5 degrees.

16. The method of claim 12, wherein the notch has a base that is curved with a radius which is approximately equal to half of the width of the notch.

17. The method of claim 12, wherein the electrical conductor is a heating conductor.
